(19) United States
(12) Patent Application Publication
(10) Pub. No.: US 2023/0394628 A1
(43) Pub. Date: Dec. 7, 2023

(54) METHOD AND APPARATUS FOR RECONSTRUCTING FACE IMAGE BY USING VIDEO IDENTITY CLARIFICATION NETWORK

(71) Applicant: Seoul National University R&DB Foundation, Seoul (KR)

(72) Inventors: Young Ki Lee, Seoul (KR); Ju Heon Yi, Seoul (KR)

(21) Appl. No.: 18/033,237

(22) PCT Filed: Apr. 22, 2022
(86) PCT No.: PCT/KR2022/005814

§ 371 Date: Apr. 21, 2023

(30) Foreign Application Priority Data
Apr. 22, 2021 (KR) 10-2021-0052399
Apr. 22, 2022 (KR) 10-2022-0050392

(51) Int. Cl. G06T 3/40; G06T 7/246; G06V 10/82; G06V 40/16; G06V 10/77; G06T 5/50; G06T 5/00; G06V 10/774

(52) U.S. Cl. CPC G06T 3/4046; G06T 7/246; G06V 10/82; G06V 40/171; G06V 10/7715; G06T 5/50; G06T 5/001; G06V 10/774; G06T 2207/20081; G06T 2207/30201; G06T 2207/10016; G06T 2207/20084

(57) ABSTRACT

A face image reconstruction method includes acquiring training data comprising at least one face image tracked from a series of frames of an input video and a ground truth face image for the at least one face image and training a video identity clarification model (video identity clarification network (VICN)) on the basis of the training data. The training includes generating, by executing a generator of the video identity clarification model, a reconstructed face image in which an identity of a face shown in the at least one face image has been clarified; and discriminating the reconstructed face image on the basis of the ground truth face image by executing a discriminator of the video identity clarification model, which is in a generative adversarial network (GAN) competition relationship with the generator.

### 1. FIELD OF THE INVENTION

The present disclosure relates to a face image reconstruction method and device and, particularly, to a method and device for reconstructing a high-resolution face image from a low-resolution face image by using an identity clarification model and/or a video identity clarification model.

### 2. DESCRIPTION OF THE PRIOR ART

Descriptions provided hereinafter are only for the purpose of providing background information related to embodiments of the present disclosure, and the contents to be described do not necessarily constitute related art. In order to recognize a face in a complex urban space, low-resolution faces taken from a long distance, which are included in an input image, need to be accurately recognized. Recently, deep neural network (DNN)-based face recognition technology has achieved high accuracy, but the recognition accuracy for low-resolution images is remarkably decreased.

A DNN-based research, which is to reconstruct a face image of low-resolution into that of high-resolution, but it is concentrated on reconstructing a visually plausible image, which does not help improve recognition accuracy.

In order to enhance the limited accuracy of the face recognition technology, a technology of reconstructing a high -resolution face image from a low-resolution face image with a small size, which is taken from a long distance, is required.

A situation in which an existing DNN model receives a single low-resolution image as an input is assumed. Accordingly, there is a limitation that, in a situation where a target face is captured over successive frames in a video, corresponding information cannot be used for reconstruction of image resolution.

The aforementioned prior art is technical information possessed by the inventor for deriving of the present disclosure or acquired during the deriving of the present disclosure, and cannot necessarily be said to be a known art disclosed to the general public prior to the filing the application of the present disclosure.

### SUMMARY OF THE INVENTION

A task of the present disclosure is to provide a face image reconstruction method and device for clarifying identity of a low-resolution face image so as to reconstruct a high-resolution face image.

A task of the present disclosure is to provide an identity clarification network (ICN) for clarification of identity of a low-resolution input image.

A task of the present disclosure is to provide a video identity clarification network (VICN) which reconstructs, into a high-resolution image, a target face image from a series of low-resolution image frames captured from successive frames of a video, and a face image reconstruction method and device using the same.

The aspects of the present disclosure are not limited to the above mentioned technical subjects, and other aspects and advantages of the present disclosure that are not mentioned will be understood through the following description and will be more clearly understood through embodiments of the present disclosure. In addition, it will be appreciated that the aspects and advantages of the present disclosure can be implemented by the means and combination thereof set forth in the claims.

A face image reconstruction method according to an embodiment of the present disclosure may include: acquiring training data including a face image and a ground truth face image for the face image; and training an identity clarification model (identity clarification network (ICN)) on the basis of the training data, wherein the training includes generating, by executing a generator of the identity clarification model, a reconstructed face image in which identity of a face shown in the face image has been clarified, and discriminating the reconstructed face image on the basis of the ground truth face image by executing a discriminator of the identity clarification model, which is in a generative adversarial network (GAN) competition relationship with the generator.

A face image reconstruction device according to an embodiment of the present disclosure may include: a memory configured to store an identity clarification model including a generator and a discriminator which is in a generative adversarial network competition relationship with the generator; and a processor configured to execute training of the identity clarification model on the basis of training data including a face image and a ground truth face image for the face image, wherein the processor is configured to, in order to execute the training, generate, by executing the generator, a reconstructed face image in which identity of a face shown in the face image has been clarified, and discriminate, by executing the discriminator, the reconstructed face image on the basis of the ground truth face image.

A face image reconstruction method executed by a face image reconstruction device including a processor, according to an embodiment of the present disclosure, may include: acquiring training data including at least one face image tracked from a series of frames of an input video and a ground truth face image for the at least one face image; and training a video identity clarification model (video identity clarification network (VICN)) on the basis of the training data, wherein the training includes generating, by executing a generator of the video identity clarification model, a reconstructed face image in which identity of a face shown in the at least one face image has been clarified, and discriminating the reconstructed face image on the basis of the ground truth face image by executing a discriminator of the identity clarification model, which is in a generative adversarial network (GAN) competition relationship with the generator.

A face image reconstruction device according to an embodiment of the present disclosure may include: a memory configured to store a video identity clarification model including a generator and a discriminator which is in a generative adversarial network competition relationship with the generator; and a processor configured to execute training of the video identity clarification model on the basis of training data including at least one face image tracked from a series of frames of an input video and a ground truth face image for the at least one face image, wherein the processor is configured to, in order to execute the training, generate, by executing the generator, a reconstructed face image in which identity of a face shown in the at least one face image has been clarified, and discriminate, by executing the discriminator, the reconstructed face image on the basis of the ground truth face image.

In addition to the above descriptions, other aspects, features, and advantages will be apparent from the following drawings, claims, and detailed description of the disclosure.

According to an embodiment, a high-resolution face image can be reconstructed by clarifying identity of a low-resolution face image.

According to an embodiment, detection accuracy of a search target, a low-resolution face image, is improved.

Effects of the present disclosure are not limited to those mentioned above, and other effects that are not mentioned will be clearly understood by those skilled in the art from the following descriptions.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a schematic illustration of an operation environment of a face image reconstruction device according to an embodiment;

FIG. 2 is a block diagram of the face image reconstruction device according to an embodiment;

FIG. 3 is a flowchart of a face image reconstruction method according to an embodiment;

FIG. 4 is a diagram for describing an identity clarification model and a training structure according to an embodiment;

FIG. 5 is a flowchart of a training procedure of a face image reconstruction method according to an embodiment;

FIG. 6 is a diagram for describing a network structure of a generator of the identity clarification model according to an embodiment;

FIG. 7 is a diagram illustrating execution results of a face image reconstruction procedure according to an embodiment;

FIG. 8 is a flowchart of a face image reconstruction method using a video identity clarification model according to an embodiment;

FIG. 9 is a diagram for describing a face tracking procedure of face image reconstruction using the video identity clarification model according to an embodiment;

FIG. 10 is a diagram for illustrating a face tracking procedure of face image reconstruction using the video identity clarification model according to an embodiment;

FIG. 11 is a diagram for describing the video identity clarification model and a training structure according to an embodiment; and

FIG. 12 is a diagram for describing a network structure of a multi-frame face resolution enhancer of a generator of the identity clarification model according to an embodiment.

### DETAILED DESCRIPTION OF THE EXEMPLARY EMBODIMENTS

Hereinafter, the present disclosure will be described in detail with reference to the accompanying drawings. The present disclosure may be implemented in various forms and is not limited to embodiments set forth herein. In the following embodiments, descriptions of features not associated directly with the present disclosure will be omitted in order to clearly explain the present disclosure, but this does not mean that these omitted features are unnecessary in implementing devices or systems to which the idea of the present disclosure is applied. Moreover, throughout the specification, the same or like reference numerals are used to designate the same or like elements.

In the following description, such terms as “first” and “second” may be used to describe various elements, but the elements should not be limited to the terms, and the above terms are used only for the purpose of distinguishing one element from another element. Also, in the following description, the singular forms are intended to include the plural forms as well, unless the context clearly indicates otherwise.

In the following description, it should be understood that the terms “include” or “have” indicate existence of a feature, a number, a step, an operation, a structural element, parts, or a combination thereof, and do not previously exclude the existences or probability of addition of one or more another features, numeral, steps, operations, structural elements, parts, or combinations thereof.

Hereinafter, the present disclosure will be described in detail with reference to the accompanying drawings.

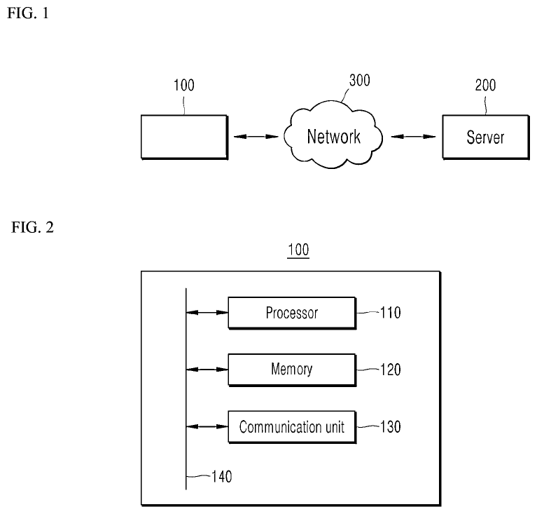

FIG. 1 is a schematic illustration of an operation environment of a face image reconstruction device according to an embodiment.

A face image reconstruction procedure according to an embodiment is a technology for high-precision face recognition, and may be applied to a deep neural network (DNN)-based face recognition algorithm so as to improve accuracy of image-based face recognition. For example, a high-complexity space includes a crowded space, such as an urban space with a high flow of people, a transfer station during rush hour, a sports stadium with a large crowd, and a shopping mall.

Face image reconstruction according to an embodiment may enable reconstruction of a high-resolution face image so that multiple small faces taken from a long distance are accurately recognizable, the multiple small faces being included in an image acquired by a camera of a terminal, for example, a smartphone, wearable glasses, or a closed-circuit television (CCTV), in a space with high complexity.

A face image reconstruction device 100 according to an embodiment may generate a reconstructed face image from an input face image by performing face image reconstruction according to an embodiment.

The face image reconstruction device 100 may enhance image quality of a low-resolution face image by a face recognition algorithm so that a small face taken from a long distance is accurately recognizable, thereby reconstructing the low-resolution face image into a high-resolution face image.

To this end, the face image reconstruction device 100 according to an embodiment may provide an identity clarification network (ICN) based on a deep neural network (DNN).

In an example, an identity clarification model introduces a training loss function and a model structure for reconstruction of a face image in order to improve face recognition accuracy by a face recognition algorithm.

In an example, the face image reconstruction device 100 may train the identity clarification model by using training data provided from a server 200 through a network 300. In an example, the face image reconstruction device 100 may transmit the trained identity clarification model to the server 200 or another terminal device through the network 300.

In an example, the face image reconstruction device 100 may receive the pre-trained identity clarification model through the network 300. For example, the face image reconstruction device 100 may receive, through the network 300, the identity clarification model trained from the server 200 or another terminal device.

The face image reconstruction device 100 may reconstruct a low-resolution face image included in an input image into a high-resolution face image by executing the trained identity clarification model. Here, the face image reconstruction device 100 may directly capture an input image or may receive an input image from the server 200 or another terminal device through the network 300.

The face image reconstruction device 100 may be implemented in a terminal or the server 200. The terminal may be a desktop computer, a smartphone, a notebook computer, a tablet PC, a smart TV, a mobile phone, a personal digital assistant (PDA), a laptop, a digital camera, a home appliance, and other mobile or non-mobile computing devices operated by a user, but is not limited thereto. The terminal may be a wearable device, such as a watch, glasses, a hair band, and a ring, having a communication function and a data processing function.

In an example, the terminal or the server 200 may reconstruct a face image included in an input image by executing an application or an app that executes face image reconstruction according to an embodiment.

The server 200 may train the identity clarification model by analyzing training data, and may provide the trained identity clarification model to the face image reconstruction device 100 through the network 300. In another example, the face image reconstruction device 100 may train the identity clarification model in an on-device manner without connection to the server 200.

The network 300 may be any appropriate communication network including wired and wireless networks, a mobile network, and a combination thereof, wherein the wired and wireless networks include, for example, local area network (LAN), wide area network (WAN), Internet, intranet, and extranet, and the mobile network includes, for example cellular, 3G, LTE, 5G, Wi-Fi networks, and an ad hoc network.

The network 300 may include connections of network elements, such as hubs, bridges, routers, and switches. The network 300 may include one or more connected networks, e.g., multiple network environments, including a public network, such as the Internet, and a private network, such as a secure enterprise private network. Access to the network 300 may be provided via one or more wired or wireless access networks.

Hereinafter, the face image reconstruction method and device according to an embodiment will be described in more detail with reference to FIG. 2 to FIG. 7.

FIG. 2 is a block diagram of the face image reconstruction device according to an embodiment.

The face image reconstruction device 100 according to an embodiment may include a memory 120 and a processor 110. Such elements are exemplary, and the face image reconstruction device 100 may include some of the elements illustrated in FIG. 2 or may additionally include an element which is, although not illustrated in FIG. 2, necessary for operation of the device.

The processor 110 is a kind of a central processing unit and may execute one or more instructions stored in the memory 120 so as to control the operation of the face image reconstruction device 100.

The processor 110 may include any type of device capable of processing data. The processor 110 may refer to, for example, a data processing device embedded in hardware, the device having a physically structured circuit to perform a function expressed as a code or an instruction included in a program.

As an example, the data processing device embedded in hardware may encompass processing devices, such as a microprocessor, a central processing unit (CPU), a graphic processing unit (GPU), a processor core, a multiprocessor, an application-specific integrated circuit (ASIC), and a field programmable gate array (FPGA), but the data processing device is not limited thereto. The processor 110 may include one or more processors.

The face image reconstruction device 100 may include the memory 120 configured to store an identity clarification model including a generator and a discriminator which is in a generative adversarial network competition relationship with the generator, and the processor 110 configured to execute training of the identity clarification model on the basis of training data including a face image and a ground truth face image for the face image.

The processor 110 may, in order to execute training of the identity clarification model, execute the generator to generate a reconstructed face image in which identity of a face shown in the face image has been clarified.

The processor 110 may be configured, in order to execute training of the identity clarification model, to execute the discriminator to perform discrimination of the face image reconstructed by the generator, on the basis of the ground truth face image.

In an example, the generator may include a face landmark estimator and a face upsampler. The processor 110 may be configured, in order to perform generation by the generator, to execute the face landmark estimator to estimate multiple face landmarks on the basis of the face image, and execute the face upsampler to upsample the face image by using the multiple face landmarks.

In an example, the generator may further include an intermediate image generator including multiple residual blocks. The processor 110 may be configured, in order to perform generation by the generator, to generate an intermediate image obtained by enhancing image quality of the face image by using the intermediate image generator, execute the face landmark estimator to estimate multiple face landmarks on the basis of the intermediate image, and execute the face upsampler to upsample the intermediate image by using the multiple face landmarks estimated based on the intermediate image.

In an example, the identity clarification model may further include a face feature extractor. The processor 110 may be configured, in order to execute training of the identity clarification model, to execute the face feature extractor to extract a feature map of the face image reconstructed by the generator and a feature map of the ground truth face image.

In an example, the processor 110 may be configured, in order to execute training of the identity clarification model, to calculate a training objective function, and alternately train the generator and the discriminator so as to minimize a function value of the training objective function.

The training objective function may include a first objective function including a GAN loss function for the generator and a second objective function based on a GAN loss function for the discriminator.

The first objective function may further include a pixel reconstruction accuracy function between the reconstructed face image and the ground truth face image, an estimation accuracy function of face landmarks estimated during the generating of the reconstructed face image, and a face feature similarity function between the reconstructed face image and the ground truth face image.

In an example, the processor 110 may be configured to execute second training of fine-tuning the identity clarification model on the basis of second training data including a face image of a search target and a reference face image for the face image of the search target.

The processor 110 may be configured, in order to execute the second training, to execute the generating and discriminating on the basis of the second training data.

The memory 120 may store a program including one or more instructions for execution of face image reconstruction according to an embodiment. The processor 110 may execute face image reconstruction according to an embodiment, based on the program and instructions stored in the memory 120.

The memory 120 may further store the identity clarification model (ICN) and a calculation result and intermediate data generated during calculation for face image reconstruction by the identity clarification model (ICN), and the like.

The memory 120 may include an internal memory and/or an external memory, and may include a volatile memory, such as a DRAM, an SRAM, or an SDRAM, a non-volatile memory, such as a one-time programmable ROM (OTPROM), a PROM, an EPROM, an EEPROM, a mask ROM, a flash ROM, a NAND flash memory, or a NOR flash memory, a flash drive, such as an SSD, a compact flash (CF) card, an SD card, a Micro-SD card, a Mini-SD card, an XD card, or a memory stick, or a storage device such as an HDD. Here, the memory 120 may include a magnetic storage medium or a flash storage medium, but is not limited thereto.

The face image reconstruction device 100 according to an embodiment may further include a communication unit 130.

The communication unit 130 includes a communication interface for data transmission and reception of the face image reconstruction device 100. The communication unit 130 may provide the face image reconstruction device 100 with various types of wired/wireless communication paths so as to connect the face image reconstruction device 100 to the network 300 with reference to FIG. 1.

The face image reconstruction device 100 may transmit/receive an input image, training data, second training data, an intermediate image, and a reconstructed image, etc. through the communication unit 130. The communication unit 130 may be configured to include, for example, at least one of various wireless Internet modules, a short-range communication module, a GPS module, a modem for mobile communication, and the like.

The face image reconstruction device 100 may further include a bus 140 that provides a physical/logical connection path between the processor 110, the memory 120, and the communication unit 130.

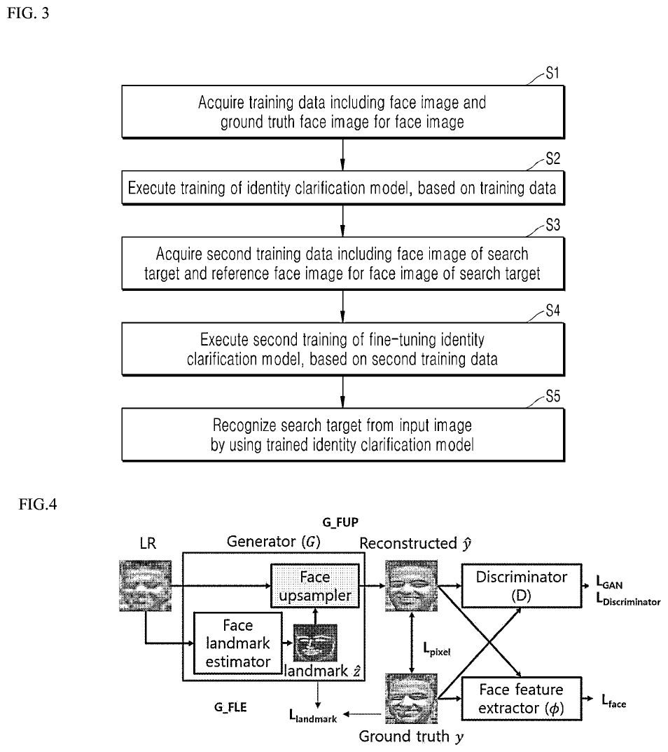

FIG. 3 is a flowchart of a face image reconstruction method according to an embodiment.

The face image reconstruction method according to an embodiment may include acquiring (operation S1) training data including a face image and a ground truth face image for the face image, and training (operation S2) an identity clarification model (identity clarification network (ICN)) on the basis of the training data.

In operation S1, the processor 110 acquires training data including a face image and a ground truth face image for the face image.

The face image is input data for an identity clarification model, and the ground truth face image for an input image corresponds to ground truth data for a reconstructed face image generated from the corresponding face image by the identity clarification model.

For example, the face image that is input data for the identity clarification model may be a low-resolution face image, and the ground truth face image may be a high-resolution face image compared to the low-resolution face image.

In an example, the processor 110 may generate a face image to be input into the identity clarification model, by downsampling the ground truth face image for the face image.

For example, the processor 110 may downsample high-resolution face photos of people having various identities so as to configure a training dataset including <high-resolution ground truth face image, low-resolution face image>. For example, the processor 110 may use an FFHQ dataset (see T. Karras et al., “A Style-Based Generator Architecture for Generative Adversarial Networks”, CVPR 2019) including about 70,000 high-resolution face images.

In an example, the processor 110 may receive a training dataset including <high-resolution ground truth face image, low-resolution face image> from the server 200 or another terminal through the network 200, with reference to FIG. 1.

In operation S2, the processor 110 executes training of the identity clarification model, based on the training data acquired in operation S1.

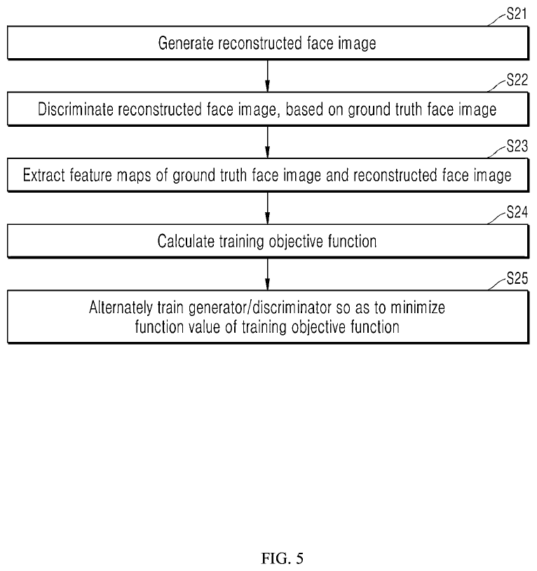

Operation S2 may include generating, by executing a generator of the identity clarification model, a reconstructed face image in which identity of a face shown in the face image has been clarified (referring to S21 of FIG. 5), and discriminating the reconstructed face image on the basis of the ground truth face image, by executing a discriminator of the identity clarification model, which is in a generative adversarial network (GAN) competition relationship with the generator (referring to S22 of FIG. 5).

In operation S2, the processor 110 executes training of the identity clarification model, based on the training dataset configured in operation S1. The identity clarification model trained via the described procedure has a capability of reconstructing any low-resolution input into a high-resolution image while preserving identity information. The identity information refers to identity information assigned based on a visual characteristic of a target face. Operation S2 will be described in detail with reference to FIG. 5.

The face image reconstruction method according to an embodiment may further include acquiring (operation S3) second training data including a face image of a search target and a reference face image for the face image of the search target, and performing second training (operation S4) of, based on the second training data, fine-tuning the identity clarification model trained in operation S2.

In operation S3, the processor 110 may configure a second training dataset including <high-resolution reference face image (probe), low-resolution face image> for the search target. For example, the processor 110 may configure the second training data for each search target by using multiple reference face images and low-resolution face images for the respective reference face images. In an example, in operation S3, the processor 110 may apply a scheme of acquiring the training data in operation S1 to acquisition of the second training data in operation S3.

In operation S4, the processor 110 may perform the second training of fine-tuning the identity clarification model trained in operation S2, based on the second training data.

In an example, the second training may include performing generation (operation S21) and discrimination (operation S22) with reference to FIG. 5 to be described later, based on the second training data acquired in operation S3.

In operation S4, the processor 110 executes the second training for fine tuning the identity clarification model trained in operation S2, by using the second training data based on the reference image for the search target. The identity clarification model which has been second-trained in operation S4 is specialized for the search target, and has a capability of reconstructing a low-resolution face image of the search target to be more similar to the search target. Operation S4 will be described with reference to FIG. 7.

Additionally, the face image reconstruction method according to an embodiment may further include recognizing (operation S5) the search target in the input image by using the identity clarification model second-trained in operation S4.

In operation S5, the processor 110 may execute the trained identity clarification model by taking, as input data, a low-resolution face image extracted from the input image, so as to reconstruct a high-resolution face image from the low-resolution face image.

In operation S5, the processor 110 may determine a similarity between the search target and at least one face area retrieved in the input image, based on the high-resolution face image reconstructed by the identity clarification model, and may determine, based on the determined similarity, whether the search target exists in the at least one face area retrieved in the input image.

Hereinafter, an identity clarification model and a training structure used in a face image reconstruction method according to an embodiment will be described with reference to FIG. 4.

FIG. 4 is a diagram for describing an identity clarification model and a training structure according to an embodiment.

In an embodiment, in order to accurately recognize a small face taken from a long distance, a deep neural network (DNN) identity clarification model (identity clarification network (ICN)) of enhancing image quality of a low-resolution input face so as to perform reconstruction into a high-resolution face image has been designed.

The identity clarification model includes a deep neural network based on a generative adversarial network structure. The identity clarification model may include a generator G configured to generate a face image (reconstructed ŷ) reconstructed from an input face image LR, and a discriminator D configured to discriminate, based on a ground truth face image (ground truth y) for the input face image LR, whether the reconstructed face image (reconstructed ŷ) generated by the generator G corresponds to the ground truth face image (ground truth y).

The generator G and the discriminator D are competition functions of the generative adversarial network (GAN), which define a GAN loss function (L_{GAN}) for the generator G and a GAN loss function (L_{Discriminator}) for the discriminator D.

The generator G includes a face landmark estimator G_FLE. The face landmark estimator G_FLE may extract at least one face landmark (landmark \hat{z}) from the low-resolution face image LR that is input to the generator G. For example, the face landmark includes face outline information and ear, eye, mouth, and nose information.

A landmark accuracy function (L_{landmark}) to be described later is defined based on a face landmark estimated by the face landmark estimator G_FLE and a face landmark extracted from the ground truth face image.

By introducing the face landmark estimator G_FLE to the identity clarification model, during high-resolution face reconstruction by the generator G, reconstruction accuracy of the high-resolution face image (reconstructed may be improved.

The generator G includes a face upsampler G_FUP. The face upsampler G_FUP generates the high-resolution face image (reconstructed reconstructed from the low-resolution face image LR, based on at least one face landmark extracted from the face landmark estimator G_FLE.

A pixel accuracy function (Lₚᵢₓₑₗ) to be described later is defined based on pixel values of the ground truth face image and the face image reconstructed by the face upsampler G_FUP.

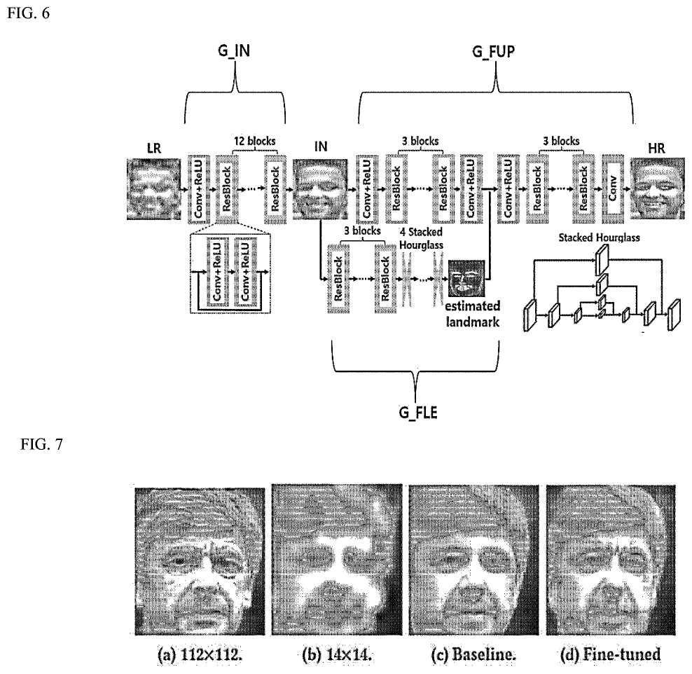

A structure of the generator G will be described later with reference to FIG. 6. The discriminator D may be configured including a residual block-based structure for GAN training.

Additionally, the identity clarification model includes a face feature extractor (ϕ). The face feature extractor (ϕ) extracts a feature map of the reconstructed face image (reconstructed ŷ) and a feature map of the ground truth face image (ground truth y).

For the face feature extractor (ϕ) a face feature similarity function (L_{face}) to be described later is defined based on the feature map of the reconstructed face image (reconstructed ŷ) and the feature map of the ground truth face image (ground truth y).

The face feature extractor (ϕ) may apply, for example, a face recognition network of a residual block-based ArcFace network structure, and without being limited thereto, may include various neural network structures for face recognition.

The face image reconstruction device 100 according to an embodiment enables the identity clarification model to obtain high reconstruction accuracy by alternately performing training so that a first objective function (Lₜₒₜₐₗ) and a second objective function (L_{Discriminator}) are minimized, wherein the first objective function allows the generator G to reconstruct a realistic face, and the second objective function allows the discriminator D to well distinguish the face reconstructed by the generator G from the ground truth face image. This will be described in operations S24 and S25 with reference to FIG. 5. FIG. 5 is a flowchart of a training procedure of the face image reconstruction method according to an embodiment.

In an example, operations S21 to S25 shown in FIG. 5 may be executed in the training in operation S2 or the second training in operation S4 with reference to FIG. 3.

In operation S21, the processor 110 may generate a reconstructed face image (reconstructed ŷ) in which identity of a face shown in a face image has been clarified, by executing the generator G of the identity clarification model.

In operation S21, the processor 110 may generate the reconstructed face image (reconstructed ŷ) in which the identity of the face shown in the input face image LR has been clarified, by executing the generator G of the identity clarification model with reference to FIG. 4.

Hereinafter, a network structure of the generator G will be described in more detail with reference to FIG. 6.

FIG. 6 is a diagram for describing a network structure of the generator of the identity clarification model according to an embodiment.

The generator G may generate an intermediate image IN by primarily enhancing image quality of a low-resolution face image LR, may estimate a face landmark from the intermediate image IN, and then may output a final high-resolution face HR by using the estimated face landmark.

In an example, the generator G includes an intermediate image generator G_IN including a neural network which generates the intermediate image IN from the low-resolution input face image LR, a face landmark estimator G_FLE including a neural network which estimates a face landmark from the intermediate image IN, and a face upsampler G_FUP including a neural network which generates an output face image HR by performing face upsampling based on the intermediate IN and the face landmark. The output face image HR corresponds to the face image (reconstructed ŷ) reconstructed with reference to FIG. 4.

The generator G may use, as a basic block structure, a residual block (see K. He et al., “Deep residual learning for image recognition”, CVPR 2016) that achieves high accuracy in various image processing.

In an example, the intermediate image generator G_IN may include multiple residual blocks. For example, the intermediate image generator G_IN may include 12 residual blocks.

In an example, the face landmark estimator G_FLE may be designed based on at least one stacked hourglass block structure. For example, the face landmark estimator G_FLE may include four stacked hourglass blocks.

In an example, the face upsampler G_FUP may include multiple sets of multiple residual blocks. For example, the face upsampler G_FUP may include two residual block sets including three residual blocks.

The intermediate image IN generated by the intermediate image generator G_IN is input to the face upsampler G_FUP and passes through a residual block set including multiple residual blocks at least once. Then, face landmark information estimated from the face landmark estimator G_FLE is introduced, and an output face image HR is generated by executing the remaining residual block sets among the multiple residual block sets of the face upsampler G_FUP.

Returning to FIG. 5, the operations S21 to S25 will be described.

In operation S21, the processor 110 may generate the reconstructed face image (reconstructed ŷ) in which the identity of the face shown in the face image has been clarified, by executing the generator G of the identity clarification model.

In operation S21, the generator G may estimate a face landmark from the input face image LR and then generate an output face image HR by using the estimated face landmark.

That is, in an example, operation S21 may include executing the face landmark estimator G_FLE of the generator G so as to estimate multiple face landmarks on the basis of the input face image LR, and executing the face upsampler G_FUP of the generator G so as to upsample the input face image LR by using the multiple face landmarks estimated in advance.

In operation S21, the generator G may generate the intermediate image IN by primarily enhancing the image quality of the low-resolution face image LR, may estimate the face landmarks from the intermediate image IN, and then may output the final high-resolution face HR by using the estimated face landmarks.

That is, in an example, operation S21 may include generating the intermediate image IN by enhancing the image quality of the input face image LR by using the intermediate image generator G_IN including multiple residual blocks, executing the face landmark estimator G_FLE of the generator G so as to estimate multiple face landmarks on the basis of the intermediate image IN, and executing the face upsampler G_FUP of the generator G so as to upsample the intermediate image IN by using the multiple face landmarks estimated by the face landmark estimator G_FLE.

In operation S22, the processor 110 may execute the discriminator D of the identity clarification model, which is in a generative adversarial network competition relationship with the generator G, so as to discriminate the reconstructed face image (reconstructed ŷ) on the basis of the ground truth face image (ground truth y).

In operation S23, the processor 110 may execute the face feature extractor (ϕ) of the identity clarification model so as to extract a feature map of the reconstructed face image (reconstructed ŷ) and a feature map of the ground truth face image (ground truth y).

Referring to FIG. 3, operation S2 may further include calculating S24 a training objective function (training loss function), and alternately performing training of the generator G and the discriminator D so as to minimize a function value of the training objective function.

In operation S24, the processor 110 may calculate the training objective function of the identity clarification model.

In an example, the training objective function of the identity clarification model may include a first objective function (L_{Total}) including a GAN loss function (L_{GAN}) for the generator G and a second objective function based on a GAN loss function (L_{Discriminator}) for the discriminator D.

In an example, the first objective function (Lₜₒₜₐₗ) may further include a pixel reconstruction accuracy function (Lₚᵢₓₑₗ) between the reconstructed face image HR and the ground truth face image (ground truth y), a estimation accuracy function (L_{landmark}) of the face landmarks estimated during the generation S21 of the reconstructed face image HR, and a face feature similarity function (L_{face}) between the reconstructed face image HR and the ground truth face image (ground truth y).

The first objective function (Lₜₒₜₐₗ) may be defined based on the GAN loss function (L_{GAN}) for the generator G, the pixel reconstruction accuracy function (Lₚᵢₓₑₗ) between the reconstructed face image HR and the ground truth face image (ground truth y), the estimation accuracy function (L_{landmark}) of the face landmarks estimated during the generation S21 of the reconstructed face image HR, and the face feature similarity function (L_{face}) between the reconstructed face image HR and the ground truth face image (ground truth y).

Hereinafter, the first objective function (Lₜₒₜₐₗ) and the second objective function (L_{Discriminator}) will be described in more detail.

In the face image reconstruction method according to an embodiment, various training objective functions have been introduced so that the identity clarification model reconstructs a high-resolution face image HR while, at the same time, preserving identity information of a target corresponding to an input face image.

(1) Pixel reconstruction accuracy (Lₚᵢₓₑₗ): L2 distance function of pixel values between the reconstructed face HR obtained by the generator G and an original face, i.e., the ground truth face image (ground truth)

$${L}_{pixel} = \frac{1}{HW} {\sum }_{i = 1}^{H} {\sum }_{j = 1}^{W} ( {‖ {y}_{i , j} - {\hat{y}}_{i , j} ‖}^{2} + {‖ {y}_{i , j} - {\hat{y}}_{i , j} ‖}^{2} ) \qquad [ Equation 1 ]$$

H and W represent the height and width of the ground truth face image (ground truth y), [symbol] _{i,j} represents an (i,j)th pixel value of the ground truth image (ground truth y), and [symbol] and [symbol] represent (i,j)th pixel values of the intermediate image IN and the final reconstructed face image HR, respectively.

(2) Face landmark estimation accuracy: L2 distance function between the ground truth and landmark coordinates estimated during the generation of the reconstructed face image by the generator G

$${L}_{landmark} = \frac{1}{N} {\sum }_{n = 1}^{N} {\sum }_{i , j} {‖ {z}_{i , j}^{n} - {z}_{i , j}^{n} ‖}^{2} \qquad [ Equation 2 ]$$

N represents a total number of face landmarks, z_{i,j}^{x} and [symbol] represent a ground truth and an estimated probability for an nth landmark in the (i,j)th pixel, respectively. For example, a total of 68 landmarks corresponding to eyes, a nose, a mouth, and a face outline may be used.

(3) Face recognition feature similarity: L2 distance function between face recognition network output features of the reconstructed face HR and the original face (ground truth)

$${L}_{face} = \frac{1}{d} {‖ ψ ( y ) - ψ ( \hat{y} ) ‖}^{2} \qquad [ Equation 3 ]$$

ψ( [symbol] ) and ψ( [symbol] ) represent output features of the face feature extractor (ϕ) for the ground truth face (ground truth y) and the high-resolution face (reconstructed [symbol] ) reconstructed by the identity clarification model, respectively. d is the number of output features, for example, a total of 512.

(4) Generative adversarial network (GAN) training objective function: Competition function between the generator G and the discriminator D, which is to make the reconstructed face (reconstructed ŷ) look realistic

L_{GAN}=−D( [symbol] )=−D(G(x))

L_{Discriminator}=D( [symbol] )−D( [symbol] )+λ(∥∇ₓ D (\hat{x})∥₂−1)² [Equation 4]

G represents the generator and D represents the discriminator.

Overall, the objective functions defined in Equations 1 to 4 are integrated as in Equation 5 so as to be used for training the identity clarification model.

Lₜₒₜₐₗ=Lₚᵢₓₑₗ+50·L_{landmark}+0.1·L_{GAN}+0.001·L_{face}

L_{Discriminator}=D( [symbol] )−D( [symbol] )+λ(∥∇ₓD(\hat{x})∥₂−1)² [Equation 5]

The identity clarification model may achieve high reconstruction accuracy by alternate training of Lₜₒₜₐₗ (objective function that allows the generator G to reconstruct a realistic face) and L_{Discriminator} (objective function that allows the discriminator D to well distinguish the reconstructed face (ŷ) obtained by the generator G from the ground truth face (y)) so as to have minimum values.

For example, when training is proceeded with using a dataset including a total of 70,000 sheets by the training objective functions, and an NVIDIA RTX 2080Ti GPU is used, a training time of approximately one day is required.

FIG. 7 is a diagram illustrating an execution result of a face image reconstruction procedure according to an embodiment. (a) is a given ground truth face image (ground truth y), (b) is an input face image LR generated by downsampling (a), (c) is a baseline image acquired as a result of executing the generator G of the identity clarification model that has completed the training in operation S2 with reference to FIG. 3, and (d) is a fine-tuned image as a result of executing the generator G of the identity clarification model that has completed the second training in operation S4 with reference to FIG. 3.

Referring to FIG. 3, the second training in operations S3 and S4 provides a fine-tuning technique using a reference image (probe) of a given search target.

As a result of analyzing a phenomenon that face recognition accuracy is significantly decreased for a low-resolution face, a dominant factor for the decrease of the face recognition accuracy for the low-resolution face is that accuracy (true positive) of determining that two faces of the same person are the same is lower than accuracy (true negative) of determining that two face images of different people are different.

In order to solve this problem, second training data including <high-resolution ground truth, low-resolution input> is configured by collecting and downsampling the high-resolution reference face image (probe) of the search target in operations S3 and S4 with reference to FIG. 3, and by using the same, the second training of performing fine-tuning on the identity clarification model is executed based on the training objective functions aforementioned in operation S24 with reference to FIG. 5.

The second training is specialized to the search target and performed, and since the number of datasets to be trained is relatively small, training is proceeded in a short time (e.g., within 1 hour on an NVIDIA RTX 2080 Ti GPU).

Through the second training technique using the reference image (probe) of the search target, the ground truth detection rate (true positive) has been improved by about 78%.

In the proposed identity clarification model, the training objective functions and model structure for reconstruction, which improve face recognition accuracy, have been introduced, and the second training by the fine-tuning technique using the reference image (probe) of the search target has been proposed.

Hereinafter, face image reconstruction using a video identity clarification model (VICN) will be described.

The face image reconstruction method using the video identity clarification model (VICN) according to an embodiment corresponds to an extension of the method, aforementioned with reference to FIG. 3, of reconstructing a face image included in an input image by using the identity clarification model (ICN), which enables processing of multiple face images included in an input video.

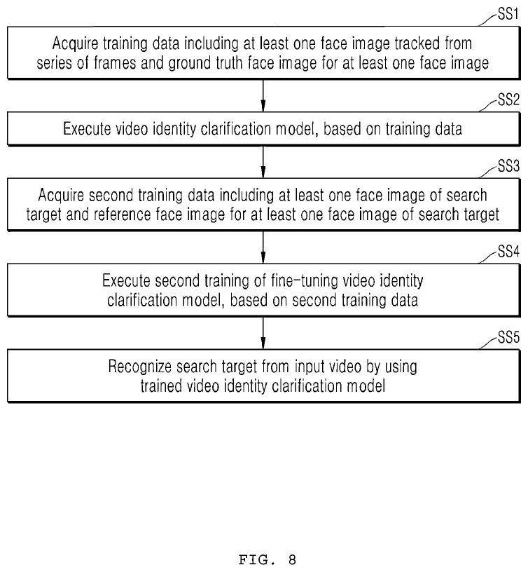

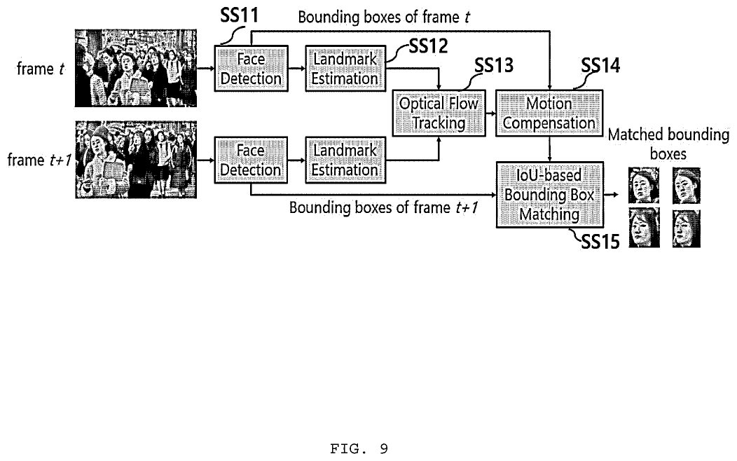

That is, the face image reconstruction method using the video identity clarification model (VICN) according to an embodiment additionally includes a configuration for reconstructing low-resolution face images included in a series of image frames into high-resolution, and descriptions will be provided hereinafter based on the additional and extended configuration with reference to FIG. 8 to FIG. 11.

The face image reconstruction method using the video identity clarification model (VICN) according to an embodiment may be executed by the face reconstruction device 100 including the processor 110, which has been aforementioned with reference to FIG. 2.

FIG. 8 is a flowchart of a face image reconstruction method using a video identity clarification model according to an embodiment.

The face image reconstruction method using the video identity clarification model according to an embodiment may include, by the processor 110, acquiring SS1 training data including at least one face image tracked from a series of frames of an input video and a ground truth image for the at least one face image, and training SS2 the video identity clarification model (VICN) on the basis of the acquired training data.

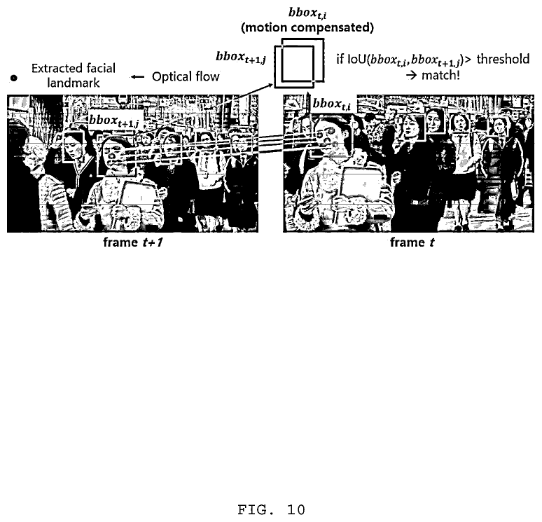

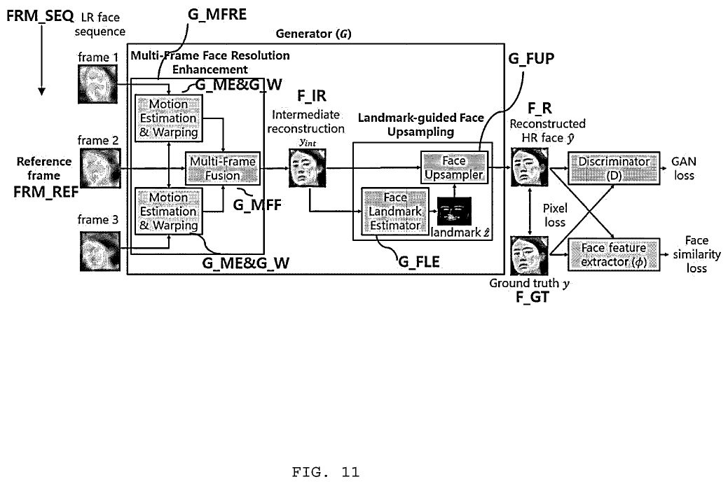

In operation SS1, the processor 110 acquires training data including at least one face image tracked from a series of frames of an input video and a ground truth image for the at least one face image. This will be described later with reference to FIGS. 9 and 10.

In operation SS2, a basic VICN model is trained based on a training dataset acquired in operation SS1. The VICN trained via the described procedure has a capability of reconstructing any low-resolution face input sequence into a high-resolution face while preserving identity information.

Operation SS2 includes executing a generator G of the video identity clarification model (VICN) so as to generate a reconstructed face image in which identity of a face shown in at least one face image has been clarified (corresponding to operation S21 with reference to FIG. 5), and executing a discriminator D of the video identity clarification model (VICN), which is in a generative adversarial network (GAN) competition relationship with the generator G, so as to discriminate the reconstructed face image on the basis of a ground truth face image (corresponding to operation S22 with reference to FIG. 5). The face image reconstruction method according to an embodiment may further include acquiring SS3 second training data including at least one face image of a search target and a reference face image for the at least one face image of the search target, and performing second training SS4 of, based on the second training data, fine-tuning the video identity clarification model (VICN) trained in operation SS2.

Operations SS3 and SS4 correspond to modifications of operations S3 and S4 aforementioned with reference to FIG. 3 so that at least one image of the search target is processed.

Operation SS3 includes collecting reference images (probes) of the search target from a video in which the search target has been captured, and configuring a training dataset including <high-resolution ground truth face sequence, low-resolution input face> via the procedure as in operation SS1.

Operation SS4 includes executing fine-tuning training of the video identity clarification model (VICN) by using the training dataset acquired in operation SS3. The trained video identity clarification model (VICN) is specialized for the search target so as to have a capability of better reconstructing the low-resolution faces of the search target.

The face image reconstruction method according to an embodiment may further include recognizing SS5 the search target in the input video by using the trained video identity clarification model (VICN). Operation SS5 performs operation S5 aforementioned with reference to FIG. 3, by using a video identity clarification model (VICN).

By operation SS5, face detection is performed from a real-time video input, and the low-resolution face sequence, which has been detected from the real-time video input by using the face feature point tracking technique of operation SS1, is reconstructed into a high-resolution face, which will be described with reference to FIG. 9.

FIG. 9 is a diagram for describing a face tracking procedure of face image reconstruction using the video identity clarification model according to an embodiment.

Referring to FIG. 8, in operation SS1, the processor 110 acquires a feature point-based face tracking (landmark-based face tracking) and a training dataset from the input video.

For example, in operation SS1, the processor 110 detects faces of people with various identities from video frames obtained by capturing an urban space. In order to map face images, which are detected from successive frames including camera movement, face movement within a scene, etc., with the same identities, the processor 110 may use a face feature point-based tracking technique.

The processor 110 may downsample the face images obtained via the face feature point-based tracking technique so as to configure a training dataset including <high-resolution ground truth face sequence, low-resolution input face>. For example, a high-resolution video dataset of a WILDTRACK dataset (Tatjana Chavdarova et al., “WILDTRACK: A Multi-Camera HD Dataset for Dense Unscripted Pedestrian Detection”, CVPR2018.), etc. may be used as the training dataset.

The video identity clarification model (VICN), which will be described later with reference to FIG. 11, receives, as an input, a face frame sequence of a person having the same identity. To this end, face detection is performed for each frame of the input video, but faces of a person with the same identity may appear at different positions over time due to camera movement or movement of an object in scenes between successive frames.

Therefore, the face recognition method according to an embodiment uses the feature point-based face tracking technique in operation SS1 in order to map faces detected by frames with the same identity in consideration of face movement between successive frames of the input video. FIG. 9 shows an overall operation structure of the face tracking procedures as described above.

An operation sequence of the face tracking procedures is as follows.

(i) Operation SS11—Face Detection: First, faces are detected in two successive input frames (frame t, frame t+1), respectively.

(ii) Operation SS12—Landmark Estimation: Landmarks (e.g., positions of eyes, a nose, and a mouth) are extracted as feature points from detected individual faces. To this end, for example, a RetinaFace detector (J. Deng et al., “RetinaFace: Single-stage Dense Face Localization in the Wild”, CVPR 2020.) capable of concurrently performing face detection and feature point extraction may be used.

(iii) Operation SS13—Optical Flow Tracking: Thereafter, an optical flow is calculated to find a corresponding landmark between frame t and frame t+1. For example, a Lukas-Kanade optical flow tracker (B. D. Lucas, T. Kanade et al., “An iterative image registration technique with an application to stereo vision.” Vancouver, British Columbia, 1981.) may be used.

(iv) Operation SS14—Motion Compensation: An average of optical flows of feature points of landmarks (e.g., eyes, a nose, and a mouth) calculated in operation SS13 is obtained. The average is assumed to be movement of an object between frames, and face bounding box coordinates of frame t are converted.

(v) Operation SS15—Intersection over Union (IoU)-based Bounding Box Matching: An area of overlapping region is calculated by calculating IoU between bounding boxes of frame t+1 and bounding boxes of frame t having undergone operation SS14 of (iv). When two bounding boxes with IoU equal to or greater than a certain value are detected, corresponding two faces are determined to have the same identity.

FIG. 10 is a diagram for illustrating a face tracking procedure of face image reconstruction using the video identity clarification model according to an embodiment.

In operation SS11 aforementioned with reference to FIG. 9, faces are detected in two successive frames (frame t, frame t+1) (bounding boxes bbox_{t,i}, bbox_{t+1,j}, etc.). In operation SS12, a landmark of each bounding box is extracted.

In operation SS13, an optical flow is calculated to find a corresponding landmark between frame t and frame t+1. In operation SS14, an average of optical flows of feature points of landmarks is obtained, the average is assumed to be movement of an object between frames, and coordinates of the bounding box of frame t (e.g., bbox_{t,i}, etc.) are converted.

In operation SS15, an area of overlapping region is calculated by calculating IoU between bounding boxes of frame t and bounding boxes of frame t+1. For example, if the IoU of bbox_{t,i} and bbox_{t+1,j} is equal to or greater than a certain value, face images represented by the two bounding boxes (bbox_{t,i} and bbox_{t+1,j}) are determined to have the same identity.

FIG. 11 is a diagram for describing the video identity clarification model and a training structure according to an embodiment.

FIG. 11 shows an exemplary training structure of the video identity clarification model (VICN).

The generator G receives a low-resolution face sequence FRM_SE Q as an input and reconstructs the same into a high-resolution face F_R. Specifically, face reconstruction via the generator G includes a first operation by a multi-frame face resolution enhancer and a second operation by a landmark-based face upsampler.

(i) First Operation—Multi-Frame Face Resolution Enhancement: The multi-frame face resolution enhancer G_MFRE obtains an intermediate-reconstructed face image y_int, F_IR having a primarily enhanced resolution by fusing the low-resolution face image sequence (e.g., frame 1, frame 2, frame 3, etc.) FRM_SEQ, which is obtained from the input video, based on a reference frame FRM_REF.

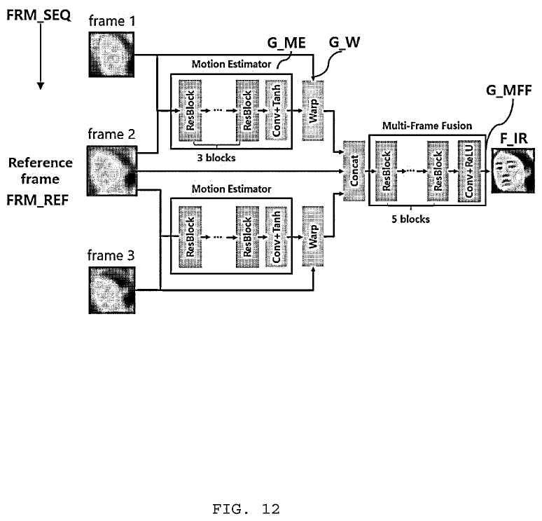

The multi-frame face resolution enhancer G_MFRE includes motion estimation G_ME, warping G_W, and a multi-frame fuser G_MFF. A specific structure will be described later with reference to FIG. 12.

(ii) Second Operation—Landmark-guided Face Upsampling: This is performed by the face landmark estimator G_FLE and the face upsampler G_FUP, and in this regard, upsampling is executed by using the intermediate-reconstructed face image F_IR in the above description with reference to FIG. 4, as the low-resolution image LR of FIG. 4.

Accordingly, the reconstructed face image F R is output, and training is performed using a ground truth image F_GT.

FIG. 12 is a diagram for describing a network structure of the multi-frame face resolution enhancer of the generator of the identity clarification model according to an embodiment.

First, in order to correct differences in a posture and an angle of a face image for each video frame of a series of frames FRM_SEQ, inter-frame motion estimation G_ME and warping G_W are performed based on a reference frame FRM_REF.

For example, a center frame of the frame sequence FRM_SEQ may be determined as the reference frame FRM_REF so that inter-frame motion is not too large, but the present disclosure is not limited thereto, and the reference frame FRM_REF may be determined in various ways.

For example, if it is assumed that there are three frames (frame 1, frame 2, and frame 3), frame 2 which is the center frame may be determined as the reference frame FRM_REF, inter-frame motion estimation G_ME and warping G_W may be performed with respect to frame 1 and frame 2, and inter-frame motion estimation G ME and warping G W may be performed with respect to frame 2 and frame 3.

For example, if it is assumed that there are five frames (frame 1, frame 2, frame 3, frame 4, and frame 5), frame 3 which is the center frame may be determined as the reference frame FRM_REF, and inter-frame motion estimation GME and warping G_W may be performed with respect to frame 1 and frame 3, frame 2 and frame 3, frame 4 and frame 3, and frame 5 and frame 3.

For example, if there are four frames (frame 1, frame 2, frame 3, and frame 4), one of frame 2 and frame 3 may be arbitrarily determined as the reference frame FRM_REF.

For example, if there are four frames (frame 1, frame 2, frame 3, and frame 4), inter-frame motion estimation G_ME and warping G_W may be performed with respect to frame 1 and frame 2, and frame 3 and frame 4.

The structure of the network G_ME for motion estimation may use a VESPCN structure (J. Caballero et al., “Real-Time Video Super-Resolution with Spatio-Temporal Networks and Motion Compensation”, CVPR 2017.) which is actively used in related tasks.

By using a residual block (K. He et al., “Deep residual learning for image recognition”, CVPR 2016.) as a basic block structure, training may be performed to extract an effective feature point for motion estimation between face frames.

The input frames warped with respect to the reference frame FRM_REF are concatenated with a channel axis of the image (concat operation) and are input to the multi-frame fuser G_MFF. For example, a concat operation may be performed on the warped input frames. For example, the concat operation may be performed on the warped input frames and the reference frame FRM_REF.

In an example, the processor 110 may perform the aforementioned motion estimation G_ME-warping G_W-multi-frame fusion G_MFF while moving a sliding window on the input frame sequence FRM SEQ in units of N frames, so as to combine N frames at once and output an intermediate-reconstructed face image F_IR.

In an example, the processor 110 may perform the aforementioned motion estimation G_ME-warping G_W-multi-frame fusion G_MFF by two successive frames of the input frame sequence FRM_SEQ, so as to enable gradual enhancement of resolution.

The exemplary multi-frame fusion network G_MFF may be trained to extract an important feature for resolution enhancement, by using, as a basic block structure, a residual block achieving high accuracy in various image processing.

The face image reconstruction method and device according to an embodiment provide a long-distance low-resolution face recognition technology, and may innovatively improve accuracy of existing mobile face recognition application which is limited to recognizing faces of 1-2 people in a short distance while having a conversation.

The face image reconstruction method and device according to an embodiment may reconstruct a high-resolution face image from a series of low-resolution face images captured over successive frames in a video. The face image reconstruction method according to an embodiment may be developed as software operable in an Android-based smartphone so as to be installed and then executed in a commercial smartphone. The DNN-based face recognition technology including an identity clarification model may be implemented with Google TensorFlow and converted to Google TensorFlow-Lite for Android so as to be executed.

The face image reconstruction technology according to an embodiment can be used for many useful mobile AR applications (e.g., finding missing children and tracking criminals) based on face recognition.

The present disclosure as described above may be implemented as codes in a computer-readable medium in which a program is recorded. The computer-readable medium includes all types of recording devices in which data readable by a computer system are stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like.

The face image reconstruction method according to an embodiment may be stored in a non-transitory computer-readable recording medium in which a computer program including one or more instructions for executing the method is recorded.

The above description of embodiments of the present disclosure is only for the porpose of illustration, and those skilled in the art will appreciate that they may be easily changed into other particular forms without departing from the technical idea or the essential featires of the present disclosure. Therefore, the embodiments set forth above should be understood not from limitative viewpoints but from illustrative viewpoints in all aspects. For example, respective constituent elements described as a single entity may be implemented as distributed entities, and likewise, constituent elements described as distributed entities may be implemented in a combined form.

The scope of the disclosure should be determined not by the above detailed description but by the appended claims, and all changes and modifications derived from the meaning and scope of the claims and equivalent concepts thereof shall be construed as falling within the scope of the disclosure.

What is claimed is:

1. A face image reconstruction method executed by a face image reconstruction device comprising a processor, the method comprising:
acquiring training data comprising at least one face image tracked from a series of frames of an input video and a ground truth face image for the at least one face image; and
training a video identity clarification model (video identity clarification network (VICN)) on the basis of the training data, wherein the training comprises:
generating, by executing a generator of the video identity clarification model, a reconstructed face image in which identity of a face shown in the at least one face image has been clarified; and
discriminating the reconstructed face image on the basis of the ground truth face image by executing a discriminator of the video identity clarification model, which is in a generative adversarial network (GAN) competition relationship with the generator.

2. The method of claim 1, wherein the acquiring of the training data comprises extracting the at least one face image from the series of frames, based on face feature point tracking information between successive frames of the series of frames.

3. The method of claim 1, wherein the generating of the reconstructed face image comprises executing a multi-frame face resolution enhancer of the generator so as to generate an intermediate-reconstructed face image from the at least one face image.

4. The method of claim 3, wherein the generating of the reconstructed face image comprises:
executing a face landmark estimator of the generator so as to estimate multiple face landmarks on the basis of the intermediate-reconstructed face image; and
executing a face upsampler of the generator so as to upsample the intermediate-reconstructed face image by using the multiple face landmarks.

5. The method of claim 4, wherein: the generating of the reconstructed face image further comprises generating an intermediate image, which is the intermediate-reconstructed face image having enhanced resolution, by using an intermediate image generator comprising multiple residual blocks;
the estimating comprises estimating the multiple face landmarks on the basis of the intermediate image; and
the upsampling comprises upsampling the intermediate image by using the estimated multiple face landmarks.

6. The method of claim 1, wherein the training of the video identity clarification model further comprises extracting, by executing a face feature extractor of the video identity clarification model, a feature map of the reconstructed face image and a feature map of the ground truth face image.

7. The method of claim 1, wherein the training of the video identity clarification model further comprises:
calculating a training objective function (training loss function); and
alternately training the generator and the discriminator so as to minimize a function value of the training objective function.

8. The method of claim 7, wherein the training objective function comprises:
a first objective function comprising a GAN loss function for the generator; and
a second objective function based on a GAN loss function for the discriminator.

9. The method of claim 8, wherein the first objective function comprises a pixel reconstruction accuracy function between the reconstructed face image and the ground truth face image, an estimation accuracy function of face landmarks estimated during the generating of the reconstructed face image, and a face feature similarity function between the reconstructed face image and the ground truth face image.

10. The method of claim 1, further comprising executing second training of fine-tuning the video identity clarification model, based on second training data comprising at least one face image of a search target and a reference face image for the at least one face image of the search target.

11. The method of claim 10, wherein the executing of the second training comprises executing the generating and the discriminating of the reconstructed face image, based on the second training data.

12. A face image reconstruction device comprising:
a memory configured to store a video identity clarification model comprising a generator and a discriminator which is in a generative adversarial network competition relationship with the generator; and
a processor configured to execute training of the video identity clarification model on the basis of training data comprising at least one face image tracked from a series of frames of an input video and a ground truth face image for the at least one face image,
wherein the processor is configured, in order to perform the executing of the training, to:
generate, by executing the generator, a reconstructed face image in which identity of a face shown in the at least one face image has been clarified; and
discriminate the reconstructed face image on the basis of the ground truth face image by executing the discriminator.

13. The device of claim 12, wherein the processor is configured to acquire the training data, and the processor is configured, in order to acquire the training data, to extract the at least one face image from the series of frames, based on face feature point tracking information between successive frames of the series of frames.

14. The device of claim 12, wherein the generator comprises a multi-frame face resolution enhancer, and
the processor is configured, in order to perform the generating of the reconstructed face image, to generate an intermediate-reconstructed face image from the at least one face image by executing the multi-frame face resolution enhancer.

15. The device of claim 14, wherein the generator further comprises a face landmark estimator and a face upsampler, and the processor is configured, in order to perform the generating of the reconstructed face image, to:
execute the face landmark estimator so as to estimate multiple face landmarks on the basis of the intermediate-reconstructed face image; and
execute the face upsampler so as to upsample the intermediate-reconstructed face image by using the multiple face landmarks.

16. The device of claim 15, wherein the generator further comprises an intermediate image generator comprising multiple residual blocks, and the processor is configured, in order to perform the generating of the reconstructed face image, to:
generate an intermediate image, which is the intermediate-reconstructed face image having enhanced resolution, by using the intermediate image generator;
execute the face landmark estimator so as to estimate the multiple face landmarks on the basis of the intermediate image; and
execute the face upsampler so as to upsample the intermediate image by using the multiple face landmarks estimated based on the intermediate image.

17. The device of claim 12, wherein the video identity clarification model further comprises a face feature extractor, and the processor is configured, in order to perform the executing of the training, to extract a feature map of the reconstructed face image and a feature map of the ground truth face image by executing a face feature extractor.

18. The device of claim 12, wherein: the processor is configured, in order to perform the executing of the training, to calculate a training objective function, and alternately train the generator and the discriminator so as to minimize a function value of the training objective function;
the training objective function comprises a first objective function comprising a GAN loss function for the generator, and a second objective function based on a GAN loss function for the discriminator; and
the first objective function comprises a pixel reconstruction accuracy function between the reconstructed face image and the ground truth face image, an estimation accuracy function of face landmarks estimated during the generating of the reconstructed face image, and a face feature similarity function between the reconstructed face image and the ground truth face image.

19. The device of claim 12, wherein the processor is configured to execute second training of fine-tuning the video identity clarification model, based on second training data comprising at least one face image of a search target and a reference face image for the at least one face image of the search target.

20. The device of claim 19, wherein the processor is configured, in order to perform the executing of the second training, to perform the generating and the discriminating of the reconstructed face image, based on the second training data.
